(19) United States
(12) Patent Application Publication
(10) Pub. No.: US 2007/0248836 A1
(43) Pub. Date: Oct. 25, 2007

(54) Quartz/solid surface laminate

(76) Inventor: John Linde, N. Tonawanda, NY (US)

Correspondence Address: SIMPSON & SIMPSON, PLLC, 5555 MAIN STREET, WILLIAMSVILLE, NY, 14221-5406, US

(21) Appl. No.: 11/410,546

(22) Filed: Apr. 25, 2006

(51) Int. Cl. B32B 27/30; B32B 27/42; B32B 27/20

(52) U.S. Cl. 428/522; 428/524; 428/537.1; 156/279

(57) ABSTRACT

The present invention relates to a method of fabricating a laminate sheet product by using heat and pressure to form thermoformable particulates, such as acrylics and/or non-thermoformable particulates, such as polyester granules, quartz, or silica, into a sheet product. The invention also includes a particulate laminate sheet product comprising a melamine or phenolic backer sheets and a layer of one or more particulates. In preferred embodiments, melamine overlay sheets are also included in the laminate sheet. The invention also includes a particulate laminate sheet product made by the method of fabricating a laminate sheet product using heat and pressure to form thermoformable particulates, such as acrylics and/or non-thermoformable particulates, such as polyester granules, quartz, or silica, into a sheet product.

### FIELD OF THE INVENTION

The field of the invention relates to laminated surface coverings, more particularly to laminated products with a hard surface for use as a working and decorative surface and still more particularly to laminated surface coverings comprising thermoformable materials, such as acrylic and acrylic solid surface particulates and/or non-thermoformable materials, such as polyester, feldspar, granite and silica particulates.

### BACKGROUND OF THE INVENTION

Presently, manufacturers are addressing the problem of achieving a lower cost solid surface sheet product similar to CORIAN®, by making thinner castings of the solid surface material and adhering it to some type of backer board or by making the article out of engineered wood products, such as MDF board or plywood, and spraying the solid surface material onto the engineered wood product.

In the first process, the sheet still has to be made on existing equipment, so the only savings is in the material. The process of attaching the sheet to the backer material, sealing the backer material, and fabricating the finished product is still there. The process demands great precision and skill from the fabricator thereby increasing labor costs. Producing the sprayed material has similar issues, as the engineered material has to be sealed and the spraying and finishing operations are very labor intensive.

The laminate products, such as FORMICA®—type laminates (“FORMICA®”) are made by making a book or stack of resin impregnated paper sheets. Typically, the bottom sheets, or backer sheets, are saturated with phenolic resin for strength. This is followed with a barrier sheet, such as a white melamine impregnated paper. On top of the barrier sheet is a decorative print sheet with the particular design. On top of the print sheet is an overlay sheet of melamine-impregnated paper. This book, or stack of sheets, is finish cured between polished stainless steel plates, which are compressed in a compression molding press with heated platens. The melamine and phenolic treated papers are cured under heat and pressure, making the hard, smooth laminate part. Melamine-impregnated papers can also be compression laminated onto MDF, particleboard and plywood.

U.S. Pat. No. 6,565,919 to Hansson, et al. provides a detailed disclosure of the use of printed media and printing methods for a decorative surface. However, the '919 patent does not teach any method or technique for incorporating acrylic or polyester particulates to provide the protective and renewable (repairable) features of acrylic or polyester sheet material such as is found with CORIAN® or similar products.

U.S. Pat. No. 6,177,499 to Minghetti discloses methods of fabricating thermoformable materials so that colors and fillers do not become imbalanced during a subsequent heating and deformation processes. However, the '499 patent does not teach any method of laminating thermoformable or non-thermoformable materials into laminated sheets using the heat and pressure methods of FORMICA®-type laminated materials. Likewise, U.S. Pat. No. 6,610,358 to Williams, et al. discloses a system and method of coating two sides of a laminated sheet material incorporating melamine and/or phenolic backer sheets, but uses kraft paper sheets, not acrylic or polyester granules, to provide the decorative element of the laminated sheet. For this reason, the sheets produced using the system and method of the '358 patent lack the structural features of solid surface materials.

U.S. Pat. No. 6,517,674 to Das discloses a process for the production of wear resistant decorative papers using spacer particles to reduce wear on laminating plates and also the manufacture of wear resistant papers by spraying glass microspheres onto papers. However, similar to the other references discussed above, the '674 patent does not disclose any method of incorporating solid surface particulates into the laminated product.

U.S. Pat. No. 6,291,078 to Chen, et al. discloses the production of surface coverings that include aluminum oxide to provide wear resistance by adding a top coat of aluminum oxide to a surface. However, it does not disclose a method including aluminum oxide in a laminated product that holds the aluminum oxide in place with a curing agent. In addition, the '078 patent fails to disclose the incorporation of thermoformable particulates, such as acrylic and/or acrylic solid surface particulates, in the finished laminated product to provide characteristics such as renewability seen in typical solid surface materials such as CORIAN®.

What is needed then is a solid surface laminate composition and a process by which a solid surface material can be formed into a laminate and combine the look, properties, and durability of a solid surface sheet with the lower cost and ease of installation of current laminated products.

### SUMMARY OF THE INVENTION

The present invention broadly comprises a method of making a solid surface laminate product comprising spreading a layer of at least one particulate material over a backer paper sheet (“backer sheet” or “barrier sheet”), with the backer sheet impregnated with melamine or a phenolic resin, positioning a laminating plate on the particulate layer, and pressing the particulate layer and the melamine impregnated sheet with a laminating plate using heat and pressure where the heat ranges from about 245° F. to about 330° F. and the pressure ranges from about 300 psi to about 1500 psi. In an alternate embodiment, a melamine impregnated paper sheet is positioned between the barrier sheet and the particulate layer. In a second alternate embodiment, at least one melamine top overlay sheet (“face sheet”) is placed between the laminating plate and the particulate layer. In still another alternate embodiment, at least one face sheet may be placed between the barrier sheet and the particulate layer and simultaneously at least one melamine face sheet between the particulate layer and the laminating plate.

The present invention also broadly comprises a particulate material laminate product comprising a layer of at least one particulate material and wetted with liquid resin and at least one paper sheet impregnated with melamine and at least one thermal initiator in the liquid resin such that the layer of at least one particulate matter is spread over the impregnated paper and pressed onto said paper at a temperature ranging between about 250-330° F. and at a pressure ranging between about 300 psi to 1500 psi. In a preferred embodiment, the particulate material laminate product further includes at least one melamine impregnated overlay sheet.

The melamine-impregnated paper is commonly used in the laminating process. The melamine resin or melamine formaldehyde resins are used to saturate the paper in an impregnating operation. The term “melamine” refers to both melamine and melamine/formaldehyde impregnated papers such as General Purpose Overlay Sheets (“face sheets” or “melamine face sheets”), Print Sheets, and Barrier Sheets, all made by AFE Industries of Crowne Pointe, N.Y. 12928. Preferably, after the paper is impregnated, it is partially cured (B stage) using curing ovens although uncured melamine paper face sheets may be used. The uniformly distributed resin, impregnated into the papers is fully cured, during the hot press lamination operation of the present invention. The melamine cures through a condensation type reaction and the material liquefies and cures, as the temperature of the material increases to the molding temperature. The melamine material is a thermoset plastic and gives off heat as it cures. The fully cured melamine/melamine formaldehyde resin results in a highly cross-linked material with an extremely hard surface. The phenolic resins are processed and cured in a similar fashion. In this invention, the barrier and face sheets supporting the particulates contain resin loaded to the required degree necessary, by the amount of resin in one or multiple sheets. The melamine-impregnated paper varies in weight from 25 to 160 grams per square meter and the melamine resin content can vary from 35 to 70%. Therefore, the paper and resin loading can be tailored to deliver the particular melamine loading required in the laminate buildup. The melamine loading can be used in bonding the solid surface layer to an engineered backer material, such as MDF board or plywood, as well as bonding the granules of the particulate layer together to provide the hard surface finish. The overlay sheet, or face sheet, is a low basic weight paper, which holds less melamine resin, thus providing durability and reducing distortion to the print or particle colors. The ratio of the weight of resin to particulate granule weight with liquid acrylic, liquid polyester or the melamine resin is in the range of 4 to 24 percent for thermoformable granules. Thus, 80 grams of particulate would require about 3 to 20 grams of resin.

In addition, the present invention also comprises a particulate material laminate product produced by the steps of spreading a layer of at least one particulate material over a melamine or phenolic impregnated barrier sheet, positioning a laminating plate on the particulate material, and pressing the particulate layer with the laminating plate using heat and pressure where the heat ranges from about 245° to about 330° F. and the pressure ranges from about 300 psi to about 1500 psi. In an alternate embodiment, a melamine impregnated face sheet is positioned between the barrier sheet and the particulate layer. In a second alternate embodiment, at least one melamine impregnated sheet is placed between the laminating plate and the particulate layer. In an additional alternate embodiment, a melamine face sheet is positioned both between the barrier sheet and the particulate layer and between the particulate layer and the laminating plate.

This invention provides the composition and process for making solid surface laminated products including laminate and laminated panels. Solid surface laminated products are defined as laminated sheets fabricated from a layer of particulate matter placed on at least one melamine or phenolic impregnated paper sheet. The platen temperature initiates the cure then the platen applies pressure to the layered materials. When the polished laminating plate is pressed directly against the particulate layer, mold release is preferably used to prevent pulling of particulates from the particulate layer.

The advantages and features of solid surface products can be achieved at a fraction of the cost of a conventional installation of a solid surface product. The amount of solid surface material in the laminate product per square foot is typically 3 to 8% of what is required for a typical half-inch thick solid surface installation. The laminate has the properties and appearance of traditional solid surface material and can be combined with solid pieces of solid surface material for special edge detail or special architectural applications. The material has improved surfacing properties as compared to traditional solid surface materials, such as CORIAN®, because the melamine makes the material more resistant to wear and scratching. In addition, in contrast to traditional (FORMICA® type) laminates, if solid surface laminates are scratched, they can be sanded and refinished or repaired (renewed). The material can be made with a textured surface. If in the future, the customer scratches or desires a smooth surface, the material can be sanded and refinished with a smooth surface.

The new invention utilizes existing equipment both in manufacturing and fabrication. The laminate is a carrier for the solid surface material as it is fused to one or more melamine impregnated sheets and sealed with a melamine overlay. In addition, solid surface sheet products (laminates) can be made by directly laminating the solid surface to suitably sized engineered wood boards or pieces and the back of the board is sealed with a conventional laminated backer sheet to balance the face laminations.

In this invention, the solid surface layer is a combination of granules, including, but not limited to, one or more of acrylic resin particulates or grinds, acrylic solid surface grinds, polyester grinds, ground urea, ground cured melamine, plastic, glass, silica, quartz, granite, feldspar, aluminum oxide, alumina trihydrate, pigments or the like, which is fused into the melamine during the curing process. The melamine solid surface laminate can be laminated to traditional phenolic treated paper, similar to the traditional laminates, such as FORMICA®, or to MDF, particleboard and plywood board. When bonding the laminate solid surface to MDF, plywood and other engineered products, the melamine-saturated buildup will bond directly to the board surface under heat and pressure with no additional adhesive. The panel laminations are run at lower pressures in the range of 300 psi to 700 psi. Higher pressure can negatively impact the integrity of some of the backing materials. The temperatures are 245° F. to about 350° F., more typically 280° F. to 305° F. Therefore, the solid surface layer can be used by itself or in combination with numerous backer materials.

The significant advantage of the product is with the composition developed. The material can be laid down uniformly with melamine sheets or phenolic sheets and processed the same as traditional laminate sheets are presently done with the solid surface particulate layer replacing the decorative printed sheet used in traditional laminates to produce the decorative pattern. The finished product can then be handled and fabricated like existing laminate.

The process also offers advantages to the furniture markets, as the solid surface laminate material can be laminated directly on engineered wood products, such as MDF board, as just described. The finished panels then provide the furniture manufacturer a cost effective method to make articles with the attractive look and functional performance of solid surface at a fraction of the price of existing solid surface materials.

In a alternate embodiment, the present invention comprises a solid surface composition comprising particulate material, a melamine or phenolic impregnated paper sheet, preferably a face sheet that has been partially cured (“B” stage”), for final curing in the press although uncured face sheets may be used. Using B stage face sheets allows for faster laminating times as the partially cured face sheet requires less time to fully cure during the laminating process. In a preferred embodiment, at least one B stage melamine-impregnated paper is placed between the particulate layer and the barrier sheet. In an alternate embodiment, at least one additional B stage face sheet is placed between the particulate layer and the other laminating plate.

In one embodiment, in which the particulate material is acrylic material, the acrylic material is softened in methylmethacrylate monomer and thermal initiator wherein the softened acrylic material is spread on the melamine impregnated paper and pressed to a flat profile on the melamine impregnated paper. The acrylic material may comprise acrylic bead resin, such as ELVACITE® made by Lucite International, Cordova, Tenn. Alternatively, it may comprise acrylic solid surface particles such as ground solid surface byproducts, or it may comprise a combination of acrylic resin and solid surface particles, which are added to acrylic resin. In one embodiment, the initiating compound, for the liquid acrylic resin coated particles is a thermal initiator, such as Akzo Nobel Trigonox®, BPIC (Akzo Nobel Polymer Chemicals, Chicago, Ill.). In one alternate embodiment, the composition further includes a crosslinker such as trimethylolpropane trimethylacrylate (TMPTMA). To provide certain properties, the claimed composition may comprise pigments and other coloring agents, silica compositions to provide scratch resistance, and filler including, but not limited to, alumina trihydrate (ATH), ground cured melamine, and/or urea particles, and/or other non-thermoformable materials in particulate form. In still another embodiment, the particulate layer may include both thermoformable particulates and non-thermoformable materials.

The present invention also broadly comprises a method in which solid surface laminate can be made in existing equipment by combining the acrylic solid surface and laminate technologies. In one embodiment, the solid surface material is obtained by grinding acrylic solid surface materials (“solid surface materials”), for example, CORIAN® grinds and/or acrylic sheets, into granules of different sizes. Different colors of granules may be used in specific amounts to obtain the desired color and appearance. Different diameter or size acrylic particles will also affect the resulting appearance of the finished product. These particles may be uniformly spread over the sheet of melamine-impregnated paper or differentially (non-uniformly) spaced to produce a particular visual effect. In one embodiment, the overlay sheet of melamine-impregnated paper is placed over the granules and a polished laminating plate is placed over the overlay sheet, while in an alternate embodiment, the polished laminating plate is placed directly on the granules. The part is pressed with heat and pressure in a range of 245°-320° F. and 300-1500 psi, respectively. Preferably, especially when using solid surface granules, the temperature is raised above the glass transition temperature, if applicable, of the granule material. At the prescribed temperature, the liquification of melamine in the sheets will start. The acrylic solid surface grinds or particulates, such as waste particulates, may have been previously cured but, under the applied heat and pressure, the particles thermoform together as they flatten, under pressure. The melamine liquefies under heat and pressure and wets out the particles and paper. The materials and melamine cure under heat and pressure. The resulting material is a melamine-acrylic solid surface material, which has superior scratch resistance and yields an attractive, yet durable finish. The amount of melamine resin required is determined by the size and amount of particles. More melamine can be added to the stack by adding additional layers of melamine impregnated paper over the barrier sheet and/or the particulate layer and/or additional melamine can be added by blending the particulate layer with ground melamine face sheets or melamine molding powder. The laminate has the look and features of solid surface products such as CORIAN®. The material is more scratch resistant than the standard acrylic or polyester solid surface materials because it is harder. The material is renewable, meaning that, like standard solid surface material, scratches can be removed by sanding the surface. The finish can then be restored by buffing or polishing.

As previously described, the acrylic component is a thermoplastic, which softens as it is heated above the glass transition temperature. Presently, laminate is made with a print sheet, e.g. FORMICA®, which is thermoformable, so the print sheet can be formed into a shape such as, for example, the front and rear edges of a laminate counter top. The laminate sheets made with a print sheet are made in a manner in which the melamine is not fully reacted. While the print sheet laminate material is thermoformed into a shape, the melamine softens under heat, is thermoformed into a desired shape, and cures (hardens) in place. Similarly, the solid surface laminate sheets are made in a similar fashion with the acrylic granules thermoformed into a desired shape, at a temperature greater than the acrylic glass transition temperature but less than what it takes to fully cure the melamine. When the sheet is reheated, the melamine softens and is thermoformed into shape. If a thicker or more thermoformable sheet is required, a liquid acrylic resin can be added to the granules when the sheet is fabricated. The additives and/or additional resins will improve the thermoformability of the laminate sheet.

The basic method described above can be utilized with numerous variations in acrylic material, additives, cross linkers, initiators and in the operational parameters of heat pressure and curing time. These variations in parameters can be made use of to produce solid surface laminates having variations in color, surface gloss, surface texture, scratch resistance and other characteristics.

An object of the invention is to provide a thin solid surface laminate sheet with thickness similar to prior art printed laminate sheets.

A second object of the invention is to provide a solid surface sheet with varying types of surfaces.

A third object of the invention is to supply a solid surface laminate board, where the solid surface material is permanently fixed to a backing material, such as MDF board or plywood.

An additional object of the invention is to provide a method of fabricating a solid surface laminate sheet.

A further object of the invention is to present a method of adhering a solid surface laminate sheet to a backing material.

These and other objects, features and advantages of the present invention will become apparent to those having ordinary skill in the art upon a reading of the following detailed description of the invention in view of the drawings.

### BRIEF DESCRIPTION OF THE DRAWINGS

The nature and mode of operation of the present invention will now be more fully described in the following detailed description of the invention in view of the accompanying drawing figures, in which:

FIG. 1 is an exploded top perspective view of a schematic diagram of one embodiment of the solid surface laminate of the present invention;

FIG. 2 is a top perspective view of the laminated layers seen in FIG. 1;

FIG. 3 is an exploded top perspective view of a schematic diagram of the solid surface laminate incorporating a design;

FIG. 4 is a top perspective view of the laminated layers seen in FIG. 3;

FIG. 5 is a side perspective view of a representative press used to perform the laminating operation to produce the solid surface laminate of the present invention;

FIG. 6 is a cross section view of a schematic diagram of one embodiment of the solid surface laminate of the present invention before heat and pressure are applied;

FIG. 7 is a cross section view the embodiment seen in FIG. 6 after heat and pressure are applied;

FIG. 8 is a top view of the solid surface laminate seen in FIG. 7;

FIG. 9 is a cross section view of a schematic diagram of a second embodiment of the solid surface laminate of the present invention before heat and pressure are applied in which non-thermoformable granules are included in the particulate matter layer;

FIG. 10 is a cross section of the embodiment shown in FIG. 9 after heat and pressure are applied; and,

FIG. 11 is a top view of the solid surface laminate seen in FIG. 10.

### DETAILED DESCRIPTION OF THE INVENTION

At the outset, it should be appreciated that like drawing numbers on different drawing views identify identical structural elements of the invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Adverting to the drawings, FIG. 1 depicts an exploded top perspective view of a schematic diagram of one embodiment of the solid surface laminate of the present invention. Solid surface laminate sheet 20 (“sheet 20”) is shown comprising three layers—melamine overlay sheet 22, particulate layer 24, and melamine or phenolic impregnated barrier sheet 26. It should be realized that other configurations within the scope of the claims may be used. For example, as explained below, a plurality of overlay sheets 22 may be placed over particulate layer 24 and/or one or more melamine impregnated sheets 22 may also be placed between barrier sheet 26 and particulate layer 24. Particulate layer 24 may comprise one or more of acrylic liquid resin, acrylic solid surface grinds, acrylic resin particles, polyester grinds, ground urea, ground cured melamine, plastic, glass, silica, quartz, granite, feldspar, aluminum oxide, aluminum trihydrate, pigments and their equivalents.

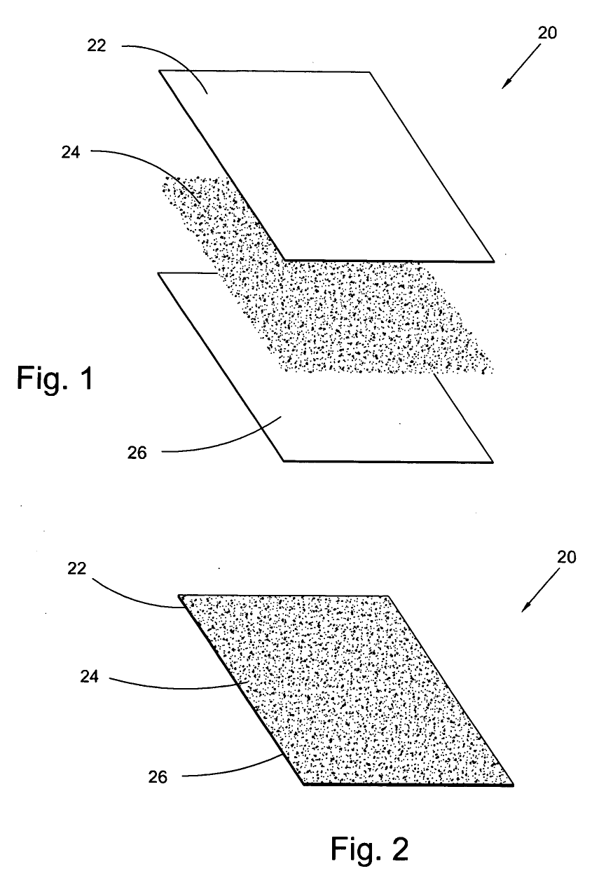

FIG. 2 is a top perspective view of sheet 20 after the laminating process has occurred. As explained below, the three or more layers shown in FIG. 1 are placed in a press and forced together under heat and pressure to form a single laminate sheet 22. A trigger or initiating temperature, ranging from 260-320° F., causes the liquification of the melamine resin in the melamine impregnated overlay sheets 22 and barrier sheet 26 begins, while the heat is applied to the laminate until the temperature of the acrylic and/or thermoplastic thermoformable particulates exceed the glass transition temperature. Heating above the glass transition temperature causes thermoformable material, including but not limited to acrylic granules and acrylic solid surface grinds, to soften and become formable (thermoformable). Simultaneously, the heat and pressure causes the melamine in the overlay sheet 22 to wet out the thermoformable particles as they push together as they flatten. As the temperature increases, the melamine also cures (hardens) around the thermoformable particles and/or other particles to form sheet 22 into a laminated sheet product.

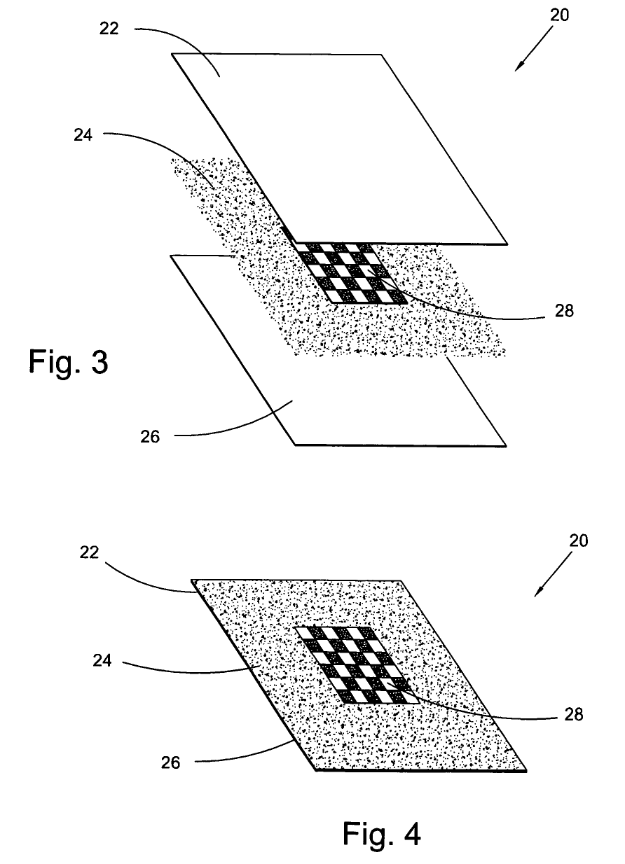

FIG. 3 is a top perspective view of laminate 20 further including a design 28 that is incorporated into the particulate layer 24 after application of heat and pressure. Design 28 may be pressed into particulate layer 24 during the application of heat and pressure or colored particulates may be strategically spread through one or more screens formed into a desired pattern or design. FIG. 4 is a top perspective view of design 28 in place in the finished sheet 20. Designs 28 can include geometric figures, logos, signs, markers and numerous other shapes and forms.

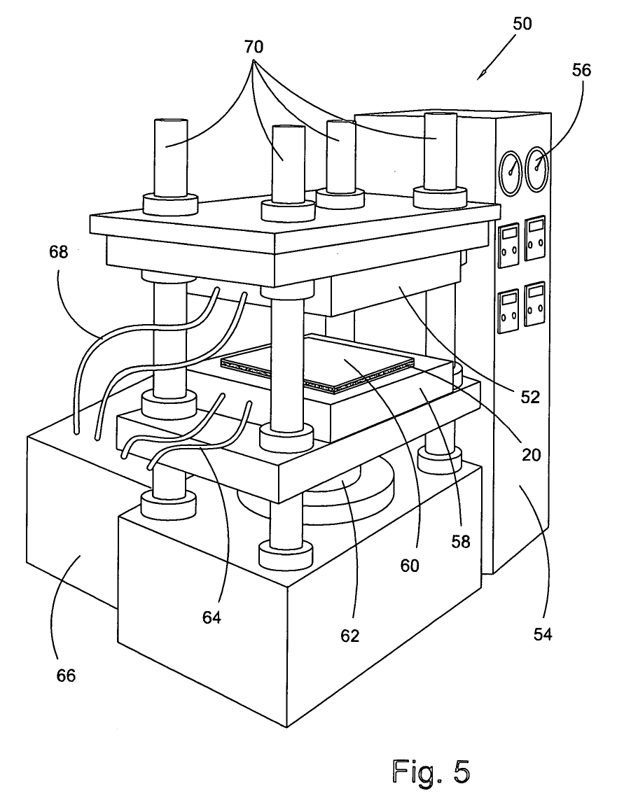

FIG. 5 is a side perspective view of a representative press 50 used to form laminate 20. Unlaminated sheet 20 is placed on lower press platen 58 under upper press platen 52. Laminating plate 60 is placed on overlay sheet 22 or, if particular finishes are desired, directly on particulate layer 24. Upper heat lines 68 run into and out of upper press platen 52 while lower heat lines 64 run into and out of lower press platen 58. Oil, water, steam or electric heaters may be used as the heat carriers. The laminating temperature ranges from 245-330° F. In a preferred embodiment, the temperature ranges from 280-310° F. In a more preferred embodiment, the temperature ranges from 284-300° F.

Hydraulic ram 62 (“ram 62”) forces lower press platen 58 against upper press platen 52 applying the force necessary to thermoform the thermoformable material in particulate layer 24 into solid surface laminate sheet 20. Laminating pressure ranges from 300-1500 lbs/sq. in. with a preferred range at 300 to 700 psi for laminating directly to panels and 300 to 1500 psi for thin laminate and are controlled from control panel 56.

It was found that the laminate sheets made with acrylic granules or acrylic solid surface granules had good structural integrity. The initial products were first made with the traditional melamine and/or phenolic impregnated sheets for strength. That is, four to six layers of phenolic or melamine impregnated sheets 26 were laid down and the acrylic solid surface granules were placed on top of the phenolic sheets to form particulate layer 24. In an alternate embodiment, where phenolic sheets are used, a white barrier sheet, containing titanium dioxide, is placed on top of the phenolic sheets, as the acrylic is somewhat translucent and the granule colors present themselves better with a white background. On top of the granules is placed an overlay melamine-impregnated face sheet 22. If particulate layer 24 had minerals included, and/or there were a lot of granules, additional melamine-impregnated sheets 22 may be placed on top of the white barrier sheet 26, underneath particulate layer 24. Overlay sheets 22 act as uniform carriers for the melamine resin. It was determined that for applications requiring extra strength, phenolic backer sheets 26 are preferably used. For applications where the commonly seen brown phenolic line is an issue in fabrication and appearance, the laminate 20 can be made without barrier sheets 26 and with an overlay sheet in its place, with the strength and rigidity maintained by the thickness of the particulate layer 24. By the thickness and composition of the granule layer, the part properties, such as strength, hardness and scratch-resistance can be determined.

The particle size is an important issue, as the combined surface area of the granules determines the amount of melamine resin required to wet out the granules. With the acrylic, acrylic solid surface granules and other thermoformable plastics, the granules are thermoformed under heat and pressure. With a given size of granules, the amount of melamine required is less for a thermoformable material as compared to non-thermoformable grinds, including but not limited to silica or quartz granules, feldspar, aluminum oxide, alumina trihydrate, and other non-thermoformable particles. Under the heat and pressure the acrylic particles are thermoformed tight together. As they flatten, very little melamine resin is required in the tight joint between the granules. In the case of silica or quartz, the granules do not deform and the melamine has to fill the spaces between the granules, increasing the melamine usage and effecting strength and clarity.

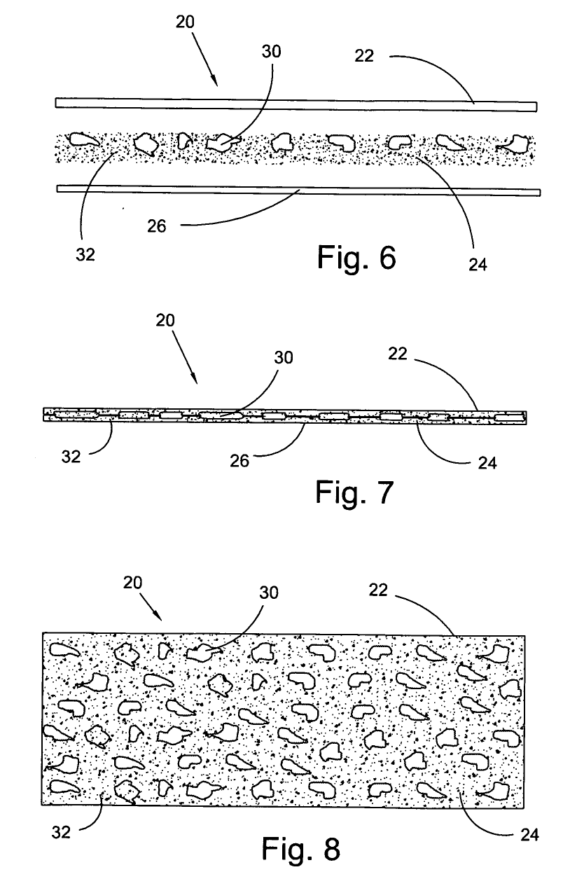

The thermoformable particles thermoform flat against the laminating plates, thus a larger visual particle is created at the surface. FIG. 6 is a schematic side view of sheet 20 before heat and pressure are applied. Thermoformable particles 30 are seen within particulate layer 24 between overlay sheet 22 and barrier sheet 26. It is to be understood that more than one overlay or impregnated sheet 22 can be used either above particulate layer 24 or between barrier sheet 26 and layer 24. FIG. 7 shows how the shape of particles 30 is changed after heat and pressure are applied. Particles 30 are flattened between overlay sheet 22 and barrier sheet 26. The melamine from face sheet 22 liquefies and is forced under pressure around particles 30. FIG. 8 is a top view of laminate sheet 20 showing how thermoformable particles 30 present a flat or spread out appearance. The melamine cures and as the particles cool below their glass transition temperature, they are locked in place in the hard material.

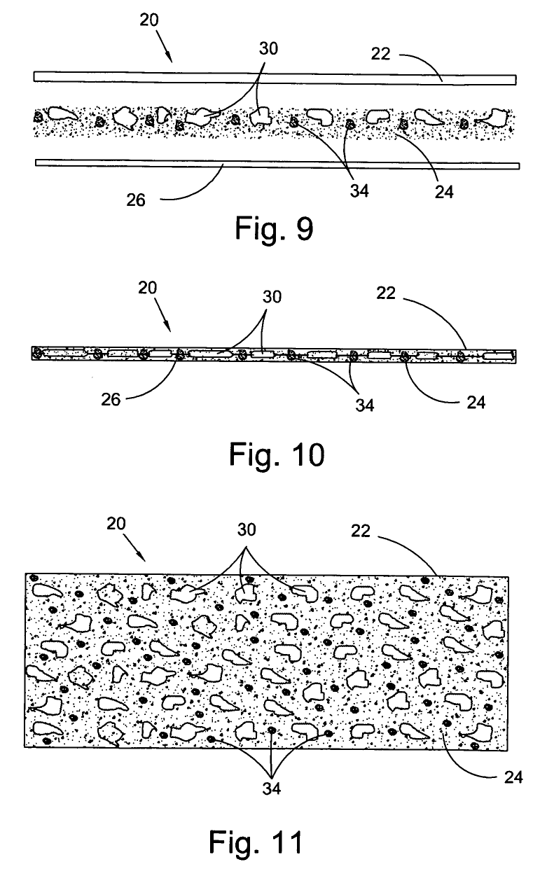

Quartz, silica or other non-thermoformable particles 34 do not flatten under the heat and pressure of the laminating process. Instead the granules will either retain their original shapes or be crushed under the pressure into smaller particles. In either case, because it does not flatten, a non-thermoformable particle 34 will not change and only the particulate surface area positioned up against the laminating plate during the curing process will be seen. It will be recognized that as the proportion of non-thermoformable particles is increased, one or more impregnated sheets 22 and 26 containing melamine may be needed. Because non-thermoformable particles 34 do not usually flatten, there is more empty space between particles 34 as compared to space between thermoformable particles 30. This empty space is filled by melamine resin to form a strong sheet 20. This is shown in FIGS. 9 and 10 depicting non-thermoformable particles 34 in non laminated sheet 20 (FIG. 9) and after lamination in FIG. 10 showing that non-thermoformable particles 34 do not flatten. FIG. 11 is a top view of the sheet shown in FIG. 10 showing how non-thermoformable particles 34 do not flatten out and only the part of the particle surface in contact with laminating plate 60 is seen on the surface of sheet 20.

It was found that from appearance, cost and processing points of view, a blend of materials is most preferred. In each case, the requirements of the final product could be custom-tailored for the various desired characteristics, such as strength (barrier sheets of phenolic or fiberglass), appearance (increased acrylics if more clarity or thermoformability is required), and for wear (added silica, quartz, glass, aluminum oxide or feldspar), if a hard, durable surface is required.

The following examples describe the production of solid surface laminate sheet materials using various particulate materials and diverse combinations of face sheets. In addition, examples are provided that demonstrate the fabrication of laminate sheet and/or the solid surface layer that is press bonded to a backer material, such as MDF board or plywood, for support. It is emphasized that these examples are not considered limiting in terms of the scope of the appended claims.

### EXAMPLE I

Large acrylic solid surface granules were soaked in methylmethacrylate monomer with an initiator Akzo Nobel Trigonox®, BPIC (Akzo Nobel Polymer Chemicals, Chicago, Ill.) which is activated at the same temperature range as the melamine impregnated paper liquefies and cures. Starting with particles ⅛″ in diameter, a piece of laminate sheet is made by uniformly laying down 30 grams of less than 50-mesh and greater than 100-mesh acrylic solid surface granules and then placing the large granules soaked in acrylic monomer in a pattern on the melamine impregnated 12″×12″ sheet. An overlay sheet is placed over the top of the granules and the part pressed with laminating plates under heat and pressure, approximately 305° F. and 550 psi (40 tons/ft²) pressure, causing the soaked granules to increase in area, up to 3/16″ in diameter on the surface. The laminate thickness was 0.065 inch. If hard materials, including but not limited to silica, quartz, and granite, are used to achieve a large aggregate look, the part will preferably be made at least as thick as the hard material size and the face may be ground away to reveal any larger diameter non-thermoformable granules.

### EXAMPLE II

To determine some of the possible variations of the invention, other nonthermoformable materials were used such as polyester solid surface granules, feldspar, silica, quartz, glass fines, fired clays and metallic pigments. A laminate sheet was made with heat and pressure similar to Example I above using alumina trihydrate (ATH), as this would yield a basic melamine solid surface material using the method described above. As with other mineral fillers, the combined surface area of the granules determines the amount of melamine resin required to wet out the particle surfaces to obtain an attractive part.

### EXAMPLE III

A laminate sheet was fabricated without melamine or phenolic backer sheets from solid surface granules sandwiched between melamine impregnated face sheets. Using the method described above, the laminate sheet had the same color on both sides and was approximately 0.05 inches thick.

### EXAMPLE IV

Example IV was similar to Example III with changes in color and increased particulate material to make the sheet thicker. The laminate sheet was 0.080 inches thick and enabled the use of larger acrylic solid surface granules using the method described above. This example demonstrated that thicker sheets can be fabricated and that the color extends throughout the thickness of the sheet making it suitable for edge detail applications as it was the same color all the way through.

### EXAMPLE V

A solid surface laminate sheet was made using the method described above and adding a white barrier sheet on one side, then placing a melamine impregnated face sheet on top of the barrier sheet. Typically, the barrier sheet receives its white color from titanium dioxide (TiO₂). On the melamine-impregnated sheet was placed fine, white acrylic solid surface granules. On top of the white material, larger colored granules were uniformly placed. On top of the granules, another melamine overlay sheet was placed. The laminate sheet produced possessed a unique distinctive pattern of large granules nested in white background material and demonstrated that a sheet having a distinctive pattern could be produced. The laminate sheet is 0.110 inches thick and is very rigid.

### EXAMPLE VI

A sample was made using 1⅛″ thick MDF board as a panel material. The 12″ by 12″ piece of MDF board was placed on a table. A piece of white melamine impregnated barrier sheet was placed on the MDF board. For added melamine, a piece of melamine impregnated sheet was cut and placed on top of the white barrier sheet. On the melamine face sheet, 32 grams of fine blended, less than 50 mesh acrylic solid surface granules were evenly spread over the sheet. The free flowing granules were broadcast over the sheet, using multiple passes to obtain a uniform distribution. The face sheet was cut to size and placed on top. The polished stainless steel laminating plate was placed on top of the stack and the assembly was moved to a press. The press platen was at 295 to 300° F. The part was pressed at a pressure of 40 tons, which is 555 PSI for six minutes. The pressure was released and the solid surface laminate/MDF backer sheet was made. The parts can be quite attractive, as various colors of granules can be blended to achieve solid or granite patterns. The particles are small, so the surface finish was quite smooth.

### EXAMPLE VII

To determine if the scratch resistance could be improved and product with a quartz-like solid surface could be made, the following sample was made. The same procedure was followed as described in Example VI with the particulate layer consisted of 24 grams of less than 50 mesh, blended acrylic solid surface granules. The solid surface granules were then blended with 8 grams of fine silica powder. The same procedure was followed, using the 12″ by 12″ MDF board with one white melamine-impregnated barrier layer, a melamine impregnated sheet, the 32 grams of acrylic solid surface granules and fine silica powder. The granules were evenly distributed on the melamine-impregnated sheets with a melamine impregnated overlay sheet placed over the granule-silica powder mixture. A steel laminating plate was placed over the face sheet. The platen was pressed on the stack at 295° F. with a pressure of 40 ton/ft² (555 PSI), for six minutes. The laminate sheet was pulled immediately without cooling (“pulled hot”) and inspected. The attractive surface is quite hard and very scratch resistant. A sharp cutting object can cut through the melamine on the face, but has a very difficult time cutting into the quartz fortified material. The bond between the melamine and MDF board was excellent. The part can be impacted with a hammer and it is very difficult to hit it hard enough to dent the surface. The adhesion is very good.

### EXAMPLE VIII

A sample was made with a method similar to Examples VI and VII but the size of the acrylic solid surface granules was increased from 50 mesh and finer (300 micron) to 12 mesh and finer (1700 micron). In this case, 45 grams of granules were used in the solid surface layer. The part was made in the same way, using 12″ by 12″ piece of MDF board with the white melamine impregnated barrier sheet and a melamine impregnated sheet on the MDF board. The granules were spread out, but there was not enough of the larger granules to give a uniform distribution. There were areas in which the background color could be seen behind the granules. The overlay sheet was applied along with the stainless steel laminating plate. The part was pressed for 5.0 minutes and pulled hot. The larger acrylic solid surface particles are a thermoplastic and they have a certain memory, when the pressure is released. The larger particles pimple the surface. It was noted that as the particle size increases, the amount of granules has to be increased to fully fill the surface area. By having more particles with a thicker bed of solid surface material, the finished part will be smoother. Preferably, the barrier melamine sheet will be the same color as the solid surface material to hide thin (less particulate) areas. The nonuniform distribution resulted in a marble or cloudy look. The projections (pimples) on the surface are random and could be beneficial such as situations in which an object(s) is being moved across a counter on a continual basis. To take advantage of the particle projection, the same test was run with 5 grams of fine silica powder added to 3.4 grams of ground melamine face sheets, which was less than 24 mesh. To this, 35 grams of a sandstone color in 12 mesh and finer (1700 micron) was added. The part was processed the same way but instead of a white melamine impregnated barrier sheet and a melamine impregnated sheet, two white melamine impregnated barrier sheets were used. The part was processed at 294° F. for 6.5 minutes at 40 ton of pressure (555 PSI) and pulled hot. The surface was textured with the larger particles. The projections are not sharp, are easy to clean, and offer wear points to protect the shiny surface from wear in applications, where food or packages are being passed on a continual basis. With the added silica and melamine, the projecting particles have excellent wear properties.

### EXAMPLE IX

A test was performed to determine if large particles can be processed. When compared to standard solid surface materials, the largest particles processed on a regular basis are 4 mesh and finer (0.187 inches). Acrylic solid surface particles 12 mesh to 4 mesh were selected. To soften them, the particles were soaked for an hour in a solution, consisting of methylmethacrylate monomer (88%), methacrylic acid 10% and an acrylic cross-linker, in this case, TMPTMA (2%) and an initiator, Akzo Nobel KSM, Akzo Nobel Chemicals, Inc., Chicago, Ill., which triggered at 270° F.

The product was prepared similar to the Examples above using a 12″×12″ MDF board. A white melamine impregnated barrier sheet was placed on the MDF board. On top of the barrier sheet was added a melamine-impregnated sheet. From the soaking solution, 30 grams of particles were pulled and the free liquid was allowed to drain off and were mixed with 20 grams of chopped melamine face sheet flakes, about ⅜ inch wide and finer. The mixture was uniformly distributed on the melamine sheet. The large granules left many open areas. To fill in the background, 16.4 grams of less than 60 mesh dry acrylic solid surface particles were evenly distributed in the open areas. The overlay sheet was added along with the stainless steel laminating plate. The part was loaded into the press and the pressure was brought up to 40 tons in one minute and held for 6 minutes. The part was then cooled in the press under pressure (“pulled cold”). The top platen was cooled to 125° F. The part had a shiny, smooth surface. The large particles were compressed and squashed. They measured up to 0.325 in. diameter. The part was cut and the large particle thickness was measured at 0.050 of an inch. The overall surface thickness was about 0.020 inches. The smooth surface resulted from cooling well below the glass transition of acrylic granules of about 210° F.

This Example demonstrates that large particles can be processed. In addition, the methylmethacrylate, methacrylic acid, cross-linker mixture with the granules can be cured with the melamine sheet flakes forming a melamine infused acrylic solid surface material. The material is very hard and scratch resistant. When compared to standard solid surface material, e.g. CORIAN®, the products are indistinguishable in appearance. It was also determined and tested, that the solid surface layer could be made thicker by adding more acrylic resin soaked particles and curing them between the melamine-impregnated sheets.

### EXAMPLE X

To determine the effects of more melamine, the same procedure was followed as previously described with the 12″×12″ MDF board. In this case, one melamine impregnated, white backer sheet and two (2) melamine impregnated face sheets were put down. On this was added 65.7 grams of dry acrylic solid surface granules, which were 12 mesh and finer (1700 micron), which with their size, covered the melamine sheets uniformly. An overlay sheet was added over the top and the part was pressed at 40 ton/ft² utilizing the stainless steel laminating plate for 6 minutes at 295° F. The pressure was released and the part was pulled hot. The part had a nice texture with slight pimpling. The part was sanded with a 240 grit sandpaper on one side of the laminate surface. After the part was sanded smooth, the part was sanded with 320 grit and buffed to a high luster. The face thickness measures 0.045 inch, which provides plenty of material to polish out scratches and refinish the surface. The material can be seamed, cut, and finished like standard solid surface material. Because the laminate has the acrylic material in it, acrylic joint adhesive (Corian® Joint Adhesive—DuPont—Wilmington, Del.) will work either for seaming or repairs. For example, a seaming application might be found in which a conventional (cast) top mount solid surface sink is installed using seam adhesive between the solid surface laminate and the solid surface bowl lip. It was noted that as particulate size increased, a greater total weight of particles was needed to uniformly cover a given area.

### EXAMPLE XI

To make the surface smoother, that is, with less texture, a sample was made using the 12″×12″ MDF board. A barrier sheet of impregnated melamine was placed on the MDF board. Over the top of this sheet, 2 sheets of impregnated melamine were placed. On top of this, a dry blended mixture of 65 grams of acrylic solid surface material, 12 mesh and finer, was uniformly distributed. On top of the solid surface particles, 40 grams of Elvacite acrylic bead resin was uniformly distributed. The overlay sheet was added and the part pressed with the laminating plate for 6 minutes at 295° F. at 40 ton per square foot pressure. The part was pulled hot and the surface had less texture. The adhesion looked good and the part had a slightly different appearance due to the acrylic powder.

### EXAMPLE XII

The issue of developing a thicker surface for more severe applications was addressed. A white melamine impregnated barrier sheet was placed on the 12″×12″ MDF board along with 2 sheets of the melamine-impregnated paper on top of the barrier sheet. On this 120 grams of blended 8 mesh and finer acrylic granules (2400 micron) was uniformly distributed. An overlay sheet was placed on top and pressed with the stainless steel laminating plate. The assembly or stack was pressed for 6 minutes at 555 PSI with a platen temperature of 295° F. and then cooled to 160° F. under pressure and pulled. The part had a beautiful finish, attractive, like a piece of fine polished solid surface material. The solid surface thickness on the part was 0.050 to 0.060 of an inch. The same test was run as above, but the laminate sheet was cooled to 200° F., under pressure and the part was very smooth. These tests demonstrated that the highly polished solid surface look could be obtained right out of the press by cooling the part under pressure without the traditional sanding and polishing operations.

### EXAMPLE XIII

The following example explores the effect of adding chopped melamine face film with particle sizes less than ⅜ of an inch to the solid surface layer. The part consisted of a 12″×12″ MDF board and on top of this was one white impregnated barrier sheet and one overlay sheet of melamine-impregnated paper. On one side of the part, a few grams of chopped overlay sheet was placed uniformly on the melamine sheet and the acrylic solid surface granules, 8 mesh and finer were uniformly distributed on top of the chopped flake. On the other side, the granules, which were 8 mesh and finer (2400 microns) were mixed uniformly with the chopped melamine face sheet. This mixture was spread uniformly over half of the part. The overlay sheet was applied over the top of the entire part and the part was pressed with the laminating plate. The part was pressed at 555 PSI for 6 minutes at 295° F. and cooled in the press under pressure. The part had a beautiful finish and there was no visual difference between the two sides. The appearance was no different with or without chopped melamine flake in the solid surface layer.

### EXAMPLE XIV

Samples were made to demonstrate the ability to make geometric and natural designs. A sample was made utilizing a 12″ by 12″ MDF board. On top of the board was placed a white melamine impregnated barrier sheet and a melamine impregnated sheet. On top of this, a uniform layer of beige acrylic solid surface granules of 8-mesh and finer were uniformly distributed. On top of this material was placed another melamine impregnated overlay sheet. A crosshatch-masking pattern (tile grout pattern) was placed on top of the overlay sheet and a uniform layer of a reddish grout colored granules of 12-mesh and finer was placed in the mask openings. The mask was pulled away and the tile pattern revealed. A melamine impregnated overlay sheet was placed on top. In the press, the pressure was brought up to 555 PSI very quickly. The melamine sheet was still brittle and the sharp particles were forced into the surface layer. The part was cured for 8 minutes at 300° F. and pulled hot from the press. The surface was quite smooth over the tiled looking areas with the two overlay levels of melamine on top. The areas over the grout line representations were slightly rough, like grout, where the particles were partially exposed on the surface. The part clearly demonstrates the ability to put down geometric patterns with granules.

### EXAMPLE XV

To incorporate a design, a screen was used, 10-mesh, in this case to block off certain areas with a graphic design. A second screen was made with the opposite pattern and a positioning method utilized, so the two screens were aligned. The MDF board was topped with a white melamine impregnated barrier sheet and an impregnated sheet for added melamine. The screen is placed in position over the stack and the first colored granules were weighed out and leveled with the aid of the screen in the open areas. The next screen can be utilized either with or without adding a melamine sheet between the two, depending on the relative granule sizes and the desired look. The second screen was added and the second colored granules were measured out and placed in the remaining areas. The screen was pulled away and an overlay sheet was placed on the stack and then pressed, in this case, for 8 minutes at 295 to 300° F. at 555 PSI. The part demonstrates the graphic capability of the process.

### EXAMPLE XVI

When duplicating veining, marble is the material used as the standard of comparison. A lot of the popular marbles are white with a distinctive vein. To replicate this look, a sample was made utilizing a 12″×12″ MDF board, one layer of white melamine impregnated barrier sheet on top of the MDF board for adhesion to the substrate and for background color. On top of the barrier sheet was placed a melamine impregnated sheet for added melamine to wet out the granules. The acrylic solid surface level consisted of 60 grams of 30×150 mesh semi translucent white granules and 20 grams of a highly pigmented white fines less than 150-mesh. The two ingredients were mixed together and uniformly distributed on the melamine sheet. An appropriately sized piece of melamine impregnated overlay sheet was fractured by hand in a way to resemble the fracture lines in a piece of marble. The sheet was then placed on the stack. A dry reddish brown pigment was selected, weighed and applied with a brush to move the pigment into the fracture lines. The fractured overlay sheet was removed and discarded leaving the pigment pattern in place. Another clean overlay sheet was applied and the part pressed at 300° F. for 8 minutes and cooled under pressure to 200° F. The pressure was 555 PSI. The part had an excellent feel and the cracks were distinctive. The surface was smooth and shiny.

### EXAMPLE XVII

A sample was made the same as the veined sample of Example XVI except the fractured impregnated melamine sheet was left on the stack. Another impregnated melamine overlay sheet was added and the part pressed for 8 minutes at 555 PSI and cooled to 200° F. The part looked good but the veining was not as distinct as the previous sample. The pigment did not get down into the solid surface particulate layer as well, so it had a more superficial veining. The surface quality, gloss and cure were excellent.

### EXAMPLE XVIII

A sample was made to verify that 13 layer, ¾″ thick Baltic birch plywood could be used as the substrate. In this test, a 12″×12″ piece of ¾″ thick Baltic birch plywood was covered with two layers of melamine-impregnated paper. On top of the paper, 110 grams of less than 24 mesh acrylic solid surface granules were uniformly spread and leveled. A top melamine-impregnated overlay sheet was put over the top of the granules. A polished steel laminating plate with the polished surface to the melamine film was added to the top of the stack. The part was placed in a compression molding press and the pressure was increased to 45 ton/ft.² at a platen temperature of 284° F. for 10 minutes. The part was cooled to 165° F. under pressure. The part was excellent. It had excellent finish, excellent surface and good particle distribution.

### EXAMPLE XIX

A sample was fabricated with glass granules, which also had photoluminescence to demonstrate that a product like engineered stone could be made in a laminate-type material. The sample was made using a ¾″ thick, 12″×12″ piece of Baltic birch, which would be an excellent substrate for a high use application, where wear resistance is important. The granules for the 12″×12″ surface consisted of 60 grams of acrylic granules smaller than 20 mesh and larger than 40 mesh. 60 grams of glow glass granules at 19 mesh and 30 grams of white acrylic solid surface granules, smaller than 30-mesh and larger than 150 mesh were added. The acrylic granules were used to increase the photo luminescent properties. A polished laminating plate was placed on the work surface. A white melamine backer sheet was placed on the polished plate. The back side of the Baltic birch was placed on the backer sheet. A white barrier sheet was placed on the front (laminate side) of the Baltic birch and on top of it was placed a melamine-impregnated paper sheet. On the sheet, the mixed granules are uniformly distributed. On top of the granules, a melamine-impregnated paper overlay sheet was placed. A polished laminating plate was placed on top of the stack and the stack was placed in a compression press with the platens at 286° F. The sheet was pressed for 10 minutes at 45 ton/ft.² and cooled under pressure to 165° F. before the press was opened. The part was excellent and the surface had a texture and was uniform. The back was sealed with a melamine backer sheet. When the face was charged with light, it had excellent glow in the dark (“black light”) properties. The part face is hard and scratch resistant, like engineered stone and also had glow in the dark properties. The back of the part was sealed with a backer sheet, which reduces the moisture penetration and balances the stress on the front and back faces of the birch plywood material.

### EXAMPLE XX

A sample was produced putting the solid surface material over CORIAN® flat stock. The first sample utilized a 12″×12″×¼″ thick piece of white CORIAN® material. The CORIAN® face was activated with a uniform surface layer of 30 grams of thermally initiated syrup. The syrup (PMMA dissolved in MMA) or activated methylmethacrylate monomer could also be used to prepare the surface for adhesion. The syrup was used as it offered a better material to nest the granules and hold them in place. Thirty-six grams of less than 50 mesh and greater than 100 mesh acrylic solid surface granules were uniformly distributed over the top of the activated resin surface. A black granite type of pattern was used. On top of the granules, one overlay sheet of melamine-impregnated paper was placed. A polished steel laminating plate was placed over the buildup and the part was placed in a press on an MDF board to compensate for any press misalignment. The platen was heated to 294° F. and the part was pressed at 30 ton/ft² for 7 minutes and cooled to 165° F. under pressure in the press. The part looked good with a new surface molded onto the original color. The surface finish and appearance were excellent and the granule distribution was good but was done by hand and could be improved slightly to obtain a more uniform granular distribution. The amount of granules could also be increased to obtain a more uniform color.

### EXAMPLE XXI

The same procedure as Example XX was followed replacing the CORIAN® with DINELLE™ acrylic solid surface material. Also, the granule size was increased to 8 mesh and finer and a thin layer of silica was added over the granules for improved wear resistance. The part was excellent and had a good surface finish and color. On the overlay sheet of melamine-impregnated paper, there was an overlap of two 7″×12″ pieces, replacing the single 12″ by 12″ sheet. The overlap area was identifiable on the finished product. Also, the silica fines reduced the clarity of the base material by using the application technique of applying a thin layer over the granules, just under the melamine-impregnated face sheet for improved wear resistance.

Samples were made varying the curing time from 2 minutes to 10 minutes. It was determined that the thicker the solid surface layer, the longer the cycle, because it takes time for the heat to penetrate through the solid surface layer to wet out the melamine impregnated sheets. The cycle times could be established by noting the gloss, surface finish and physical properties of the finished part. The thicker solid surface laminate material samples were cured at 8 minutes at 300° F. under 555 pounds per square inch of pressure. The samples were cooled to 160° F. with very good results. The surface was perfect with good gloss and the properties were good. In the process, it requires a certain amount of time to heat the acrylic solid surface particles and thermoform them together before they can effectively pass the heat on to the melamine impregnated sheets. This heating time is dependent on the thickness of the solid surface granule/acrylic layer as originally laid down in the buildup.

### EXAMPLE XXII

A ¼″ thick piece of Corian® 12″×12″ was used. The selected surface was coated with thermally activated syrup, utilizing a roller to obtain a thin, uniform layer. On top of the syrup, a melamine-impregnated paper was laid down uniformly. On top of the melamine-treated paper the following mixture of granules was uniformly distributed on the sheet to obtain a uniform thickness of granules: 70 grams of beige solid surface material, less than 12 mesh; five grams of a dark brown solid surface material less than 12 mesh and 25 grams of a fine silica powder. Over the top of this buildup, was placed a melamine-impregnated paper overlay sheet. Utilizing a polished steel laminating plate on top of the buildup, the assembly was compressed in a press with the top platen at 290° F. for 7 minutes and cooled under the molding pressure of 35 tons/ft² to 165° F. The part looked good and demonstrated the concept but also showed that the process could be improved by altering pressure, temperature and buildup techniques.

### EXAMPLE XXIII

In a procedure similar to Example XXII, the granule size of the non-silica particles was increased to 8 mesh and finer and the melamine-impregnated paper sheet utilized over the syrup was not used. In this case, the CORIAN® material was activated with the syrup with a roller. The mixture of less than 8 mesh solid surface granules and silica powder was uniformly distributed over the activated syrup level. Over the top of the granules, the melamine-impregnated paper overlay sheet was applied and the stack was processed as previously described. The finished part has an excellent finish, particle distribution, clarity, and adhesion.

The surface finish improved with increased cure time up to a point, when the parts were pulled hot. If the surface layer from the melamine backer sheets had infused the particles and the backer sheets were softened but not fully wetted out, the pebbly surface was more pronounced. If the surface was infused into the flattened acrylic solid surface particles and they, in turn, were infused tightly with the barrier sheet, the best surface finish was achieved for a part pulled hot. The finish improves to a point and then no further, as improvement with time is noted. The surface finish duplicates the finish of the laminating plate, when allowed to cool under pressure. Thus, if the laminating plate is polished, the part will be polished. If the part is pulled hot, the thermoplastic CORIAN® particles will partially recover their shape, yielding a somewhat pebbly surface. The thicker the material compared to the relative size of the granules and the better the parts are thermoformed together and nested to the melamine substrate sheets, the better the surface, that is, the smoother and glossier it is.

### EXAMPLE XXIV

Solid surface laminate sheets were made as previously described where a smaller, precut barrier sheet is placed on top of the granules for a logo or other laminate presentation. The decorative or print sheet was sized the same as the barrier sheet and they were nested together on top of the granules. The overlay sheet was placed on top, covering both the granules and logo print. The part was pressed to yield a granite looking frame for the logo. To demonstrate that the concept could be used on irregular surfaces, a special perform was made. A barrier sheet was placed on a laminating plate, on top of it was placed melamine-impregnated paper. A mixture of methylmethacrylate monomer at 80% and fine dissolved acrylic bead resin at 20% was made up with a thermal initiator. The syrup consistency liquid material was brushed onto the melamine-impregnated paper. The solid surface granules were then uniformly placed on the piece. The solid surface granules stuck where they fell. The part can be pressed with an overly right away or it can be allowed to dry and the granules will continue to stay stuck to the melamine-impregnated paper and they can be processed at a later time.

It will be recognized by those skilled in the art that the different examples described above incorporating a backer material, such as MDF board, e.g. placing a design into the laminate sheet, may be carried out without the backer material, as in making standard laminate type materials.

Thus it is seen that the objects of the invention are efficiently obtained, although changes and modifications to the invention should be readily apparent to those having ordinary skill in the art, which changes would not depart from the spirit and scope of the invention as claimed.

I claim:

1. A method of making a solid surface laminate product comprising:
spreading a layer of at least one particulate material over a first sheet, said first sheet impregnated with melamine or a phenolic resin;
positioning a laminating plate on said layer; and,
pressing said layer and said barrier sheet with a laminating plate using heat and pressure,
wherein said heat ranges from about 245° F. to about 320° F. and said pressure ranges from about 300 psi to 1500 psi.

2. The method of making a solid surface laminate product as recited in claim 1 further comprising placing at least one second melamine impregnated sheet between said particulate material and said laminating plate.

3. The method of making a solid surface laminate product as recited in claim 1 further comprising placing at least one additional first melamine impregnated sheet between said first sheet and said particulate layer.

4. The method of making a solid surface laminate product as recited in claim 1, wherein said barrier sheet is impregnated with partially cured melamine.

5. The method of making a solid surface laminate product as recited in claim 1, wherein the quantity of said melamine ranges from 4-20% of said particulate layer by weight.

6. The method of making a solid surface laminate product as recited in claim 2, wherein the quantity of said melamine ranges from 4-20% of said particulate layer by weight.

7. The method of making a solid surface laminate product as recited in claim 1 wherein said temperature range is from about 280-306° F.

8. The method of making a solid surface laminate product as recited in claim 1 wherein said pressure is about 550 psi, for making either laminate or laminating directly on engineered material such as MDF board.

9. The method of making a solid surface laminate product as recited in claim 1 wherein said particulate material comprises thermoformable material.

10. The method of making a solid surface laminate product as recited in claim 9 wherein said thermoformable material comprises acrylic material.

11. The method of making a solid surface laminate product as recited in claim 10 wherein said thermoformable material comprises acrylic bead resin.

12. The method of making a solid surface laminate product as recited in claim 10 wherein said thermoformable material comprises acrylic grinds.

13. The method of making a solid surface laminate product as recited in claim 10 wherein said thermoformable material comprises acrylic resin and acrylic grinds.

14. The method of making a solid surface laminate product as recited in claim 9 further comprising liquid acrylic and/or polyester resin.

15. The method of making a solid surface laminate product as recited in claim 1 wherein said particulate material comprises polyester grinds.

16. The method of making a solid surface laminate product as recited in claim 1 wherein said particulate material comprises non-thermoformable material.

17. The method of making a solid surface laminate product as recited in claim 16 wherein said non-thermoformable material is silica.

18. The method of making a solid surface laminate product as recited in claim 16 wherein said non-thermoformable material is quartz.

19. The method of making a solid surface laminate product as recited in claim 16 wherein said non-thermoformable material is granite.

20. The method of making a solid surface laminate product as recited in claim 16 wherein said non-thermoformable material is feldspar.

21. The method of making a solid surface laminate product as recited in claim 16 wherein said non-thermoformable material is aluminum oxide.

22. The method of making a solid surface laminate product as recited in claim 16 wherein said non-thermoformable material is alumina trihydrate.

23. The method of making a solid surface laminate product as recited in claim 14 wherein said non-thermoformable material is plastic.

24. The method of making a solid surface laminate product as recited in claim 16 wherein said non-thermoformable material is at least one pigment.

25. The method of making a solid surface laminate product as recited in claim 1 further comprising cooling said laminate under pressure to or below 160° F.

26. The method of making a solid surface laminate product as recited in claim 1 further comprising cooling said laminate under pressure to or below 125°.

27. The method of making a solid surface laminate product as recited in claim 7 further comprising releasing said laminate from said pressure above the glass transition temperature of said particulate layer.

28. The method of making a solid surface laminate product as recited in claim 7 further comprising releasing said laminate from said pressure below the glass transition temperature of said particulate layer.

29. The method of making a solid surface laminate product as recited in claim 1 further comprising arranging a melamine-impregnated sheet adjacent to backer material, such as MDF board, so the lamination is made and bonded in one operation.

30. The method of making a solid surface laminate product as recited in claim 29 wherein said backer material is plywood.

31. The method of making a solid surface laminate product as recited in claim 29 wherein said backer material is MDF board.

32. The method of making a solid surface laminate product as recited in claim 29 wherein said backer material is solid surface material and further comprises an activating syrup spread on said solid surface material.

33. The method of making a solid surface laminate product as recited in claim 10 wherein said particulate layer comprises acrylic solid surface granules are 8 mesh and finer in size.

34. The method of making a solid surface laminate product as recited in claim 10 further comprising soaking said acrylic material in a liquid acrylic monomer.

35. The method of making a solid surface laminate product as recited in claim 10 wherein said particulate layer further comprises melamine overlay or decorative sheet flakes.

36. The method of making a solid surface laminate product as recited in claim 1 wherein some or all of said particulate layer is spread through a first screen shaped into a desired design.

37. The method of making a solid surface laminate product as recited in claim 36 wherein some or all of said particulate layer is spread through a second screen shaped into an opposite design screen aligned with said first screen.

38. The method of making a solid surface laminate product as recited in claim 2 wherein said at least one melamine overlay sheet comprises fracture lines and further comprising moving one or more pigments into said fracture lines.

39. The method of making a solid surface laminate product as recited in claim 2 wherein said at least one print sheet with a design is placed on the solid surface granules with or without a barrier sheet and the solid surface granules and print sheet are covered with an overlay sheet.

40. A particulate material laminate product comprising;
a layer of at least one particulate material; and,
at least one or more impregnated barrier sheets, wherein said barrier sheet is impregnated with melamine or a phenolic resin;
wherein said layer of at least one particulate matter is spread over said impregnated barrier sheet and pressed onto said barrier sheet at a temperature ranging between about 250-330° F. and at a pressure ranging between about 300-1500 psi

41. The particulate material laminate product as recited in claim 40 further comprising a first at least one melamine impregnated overlay sheet.

42. The particulate material laminate product as recited in claim 40 wherein the quantity of said melamine ranges from about 4-20% of said particulate material by weight.

43. The particulate material laminate product as recited in 41 wherein the quantity of said melamine ranges from about 4-20% of said particulate material by weight.

44. The particulate material laminate product as recited in claim 41 further comprising a second melamine impregnated overlay sheet on an opposite side from said first at least one melamine impregnated overlay sheet.

45. The particulate material laminate product as recited in claim 40 wherein said particulate material comprises a thermoformable material.

46. The particulate material laminate product as recited in claim 45 wherein said thermoformable material is acrylic material.

47. The particulate material laminate product as recited in claim 46 wherein said acrylic material comprises acrylic resin.

48. The particulate material laminate product as recited in claim 46 wherein said acrylic material comprises acrylic grinds.

49. The particulate material laminate product as recited in claim 46 wherein said acrylic material comprises acrylic resin and acrylic grinds.

50. The particulate material laminate product as recited in claim 40 wherein said particulate material comprises polyester grinds.

51. The particulate material laminate product as recited in claim 40 wherein said particulate material comprises non-thermoformable material.

52. The particulate material laminate product as recited in claim 51 wherein said non-thermoformable material comprises quartz particulates.

53. The particulate material laminate product as recited in claim 51 wherein said non-thermoformable material comprises granite particulates.

54. The particulate material laminate product as recited in claim 51 wherein said non-thermoformable material comprises silica particulates.

55. The particulate material laminate product as recited in claim 51 wherein said non-thermoformable material comprises feldspar particulates.

56. The particulate material laminate product as recited in claim 51 wherein said non-thermoformable material comprises aluminum oxide.

57. The particulate material laminate product as recited in claim 51 wherein said non-thermoformable material comprises alumina trihydrate.

58. The particulate material laminate product as recited in claim 51 wherein said non-thermoformable material comprises plastic grinds.

59. The particulate material laminate product as recited in claim 51 wherein said non-thermoformable material comprises at least one pigment.

60. The particulate material laminate product as recited in claim 59 wherein said pigment is a black light activated pigment.

61. The particulate material laminate product as recited in claim 40 further comprising a backer material.

62. The particulate material laminate product as recited in claim 61 wherein said backer material is plywood.

63. The particulate material laminate product as recited in claim 61 wherein said backer material is MDF board.

64. The particulate material laminate product as recited in claim 61 wherein said backer material is solid surface material and further comprising an activating sirup spread on said solid surface material.

65. The particulate material laminate product as recited in claim 40 wherein said particulate material comprises melamine overlay sheet flakes.

66. The particulate material laminate product as recited in claim 40 wherein some or all of said layer of at least one particulate material is spread through a first screen shaped into a design.

67. The particulate material laminate product as recited in claim 66 wherein some or all of said layer of at least one particulate material is spread through a second screen shaped into an opposite design, the design of said second screen aligned with said design of said first screen.

68. The particulate material laminate product as recited in claim 43 wherein at least one of said at least one melamine overlay sheet is fractured and further comprising at least one pigment moved into some or all of said fracture lines.

69. The particulate material laminate product as recited in claim 43 wherein said at least one melamine overlay or print sheet comprises a design, said design pressed into said layer of at least one particulate material.

70. A particulate material laminate product produced by the steps of:
spreading a layer of at least one particulate material over at least one first sheet, said first sheet impregnated with melamine or a phenolic resin;
positioning a laminating plate on said particulate material; and,
pressing said layer with said laminating plate using heat and pressure,
wherein said heat ranges from about 245 to about 330° F. and said pressure ranges from about 300-1500 psi

71. The particulate material laminate product as recited in claim 70 further comprising at least one second melamine impregnated sheet placed between said particulate layer and said backer sheet.

72. The particulate material laminate product as recited in claim 70 wherein the weight of said melamine ranges from about 4-20% of said particulate material by weight.

73. The particulate material laminate product as recited in claim 71 wherein the weight of said melamine ranges from about 4-20% of said particulate material by weight.

74. The particulate material laminate product as recited in claim 70 wherein said backer sheet comprises partially cured melamine.

75. The particulate material laminate product as recited in claim 70 wherein said temperature range is about 250 to about 310° F.

76. The particulate material laminate product as recited in claim 75 wherein said temperature range is from about 280 to about 306° F.

77. The particulate material laminate product as recited in claim 70 wherein said pressure is about 550 psi.

78. The particulate material laminate product as recited in claim 70 wherein said at least one particulate material comprises thermoformable material.

79. The particulate material laminate product as recited in claim 78 wherein said thermoformable material comprises acrylic material.

80. The particulate material laminate product as recited in claim 79 wherein said acrylic material comprises acrylic resin.

81. The particulate material laminate product as recited in claim 79 wherein said acrylic material comprises acrylic grinds.

82. The particulate material laminate product as recited in claim 79 wherein said acrylic material comprises acrylic resin and acrylic grinds.

83. The particulate material laminate product as recited in claim 70 further comprising liquid acrylic resin and/or liquid polyester resin.

84. The particulate material laminate product as recited in claim 70 wherein said particulate material comprises polyester grinds.

85. The particulate material laminate product as recited in claim 70 wherein said at least one particulate material comprises non-thermoformable material.

86. The particulate material laminate product as recited in claim 85 wherein said non-thermoformable material comprises silica particulate material.

87. The particulate material laminate product as recited in claim 85 wherein said non-thermoformable material comprises quartz particulate material.

88. The particulate material laminate product as recited in claim 85 wherein said non-thermoformable material comprises granite particulate material.

89. The particulate material laminate product as recited in claim 85 wherein said non-thermoformable material comprises feldspar particulate material.

90. The particulate material laminate product as recited in claim 85 wherein said non-thermoformable material comprises aluminum oxide particulate material.

91. The particulate material laminate product as recited in claim 85 wherein said non-thermoformable material comprises aluminum trihydrate particulate material.

92. The particulate material laminate product as recited in claim 85 wherein said non-thermoformable material comprises plastic particulate material.

93. The particulate material laminate product as recited in claim 85 wherein said non-thermoformable material comprises at least one pigment.

94. The particulate material laminate product as recited in claim 93 wherein said pigment is a black light activated pigment.

95. The particulate material laminate product as recited in claim 70 wherein said laminate product is cooled under pressure to or below 160° F.

96. The particulate material laminate product as recited in claim 70 wherein said laminate product is cooled under pressure to or below 125° F.

97. The particulate material laminate product as recited in claim 78 wherein said laminate product is released from said pressure above the glass transition point of said particulate layer.

98. The particulate material laminate product as recited in claim 78 wherein said laminate product is released from pressure at a temperature below the glass transition point of said particulate layer.

99. The particulate material laminate product as recited in claim 70 further comprising a backer material produced by the method further comprising arranging a backer material adjacent said backer sheet.

100. The particulate material laminate product as recited in claims 99 wherein said backer material is plywood.

101. The particulate material laminate product as recited in claims 99 wherein said backer material is MDF board.

102. The particulate material laminate product as recited in claims 99 wherein said backer material is solid surface material and produced by the additional step of spreading an activating sirup on said solid surface material.

103. The particulate material laminate product as recited in claims 78 wherein said at least one particulate comprises acrylic solid surface granules about 8 mesh and smaller in size.

104. The particulate material laminate product as recited in claim 78 wherein said acrylic material is soaked in a liquid acrylic monomer.

105. The particulate material laminate product as recited in claim 78 further comprising ground melamine overlay and/or decorative sheets.

106. The particulate material laminate product as recited in claim 70 wherein some or all of said at least one particulate material is spread into said layer through a first screen shaped into a design.

107. The particulate material laminate product as recited in claim 106 wherein some or all of said particulate material is spread onto said layer through a second screen shaped into an opposite design screen and aligned with said first screen.

108. The particulate material laminate product as recited in claim 71 wherein at least one of said at least one melamine overlay sheet comprises fracture line and further comprising the step of moving pigment into said fracture lines.

109. The particulate material laminate product as recited in claim 71 wherein said at least one of said at least one melamine print sheet includes a design wherein said design is pressed into said laminate under the overlay.

110. The method of making a solid surface laminate product as recited in claim 2 wherein at least one of said at least one second melamine impregnated sheet comprises partially cured melamine.

111. The method of making a solid surface laminate product as recited in claim 3 wherein at least one additional and/or said first sheet comprises partially cured melamine.

112. The method of making a solid surface laminate product as recited in claim 1 wherein said first sheet comprises titanium dioxide.

113. The particulate material laminate product as recited in claim 71 wherein at least one of said at least one second melamine impregnated sheet comprises partially cured melamine.

114. The particulate material laminate product as recited in claim 70 wherein at least one of said at least one first sheet comprises partially cured melamine.

115. The particulate material laminate product as recited in claim 1 wherein at lest one of said at lest one first sheet comprises titanium dioxide.
